(19) United States
(12) Patent Application Publication
(10) Pub. No.: US 2015/0041723 A1
(43) Pub. Date: Feb. 12, 2015

(54) CHEMICALLY BONDED CERAMICS BASED ON BORON AND LEAD

(71) Applicant: THE REGENTS OF THE UNIVERSITY OF CALIFORNIA, Oakland, CA (US)

(72) Inventors: Jenn-Ming Yang, Willowbrook, IL (US); Henry A. Colorado, Willowbrook, IL (US)

(21) Appl. No.: 14/381,163

(22) PCT Filed: Feb. 25, 2013
(86) PCT No.: PCT/US2013/027672

§ 371 Date: Aug. 26, 2014

Related U.S. Application Data
(60) Provisional application No. 61/603,865, filed on Feb. 27, 2012.

(51) Int. Cl. G21F 1/06

(52) U.S. Cl. CPC G21F 1/06
USPC 252/478

(57) ABSTRACT

Chemically bonded ceramics and manufacturing processes are described. In one aspect, a manufacturing process of a chemically bonded ceramic is carried out by: (1) combining an acidic liquid and solids to form a mixture; and (2) curing the mixture to form the chemically bonded ceramic. The solids include a boron compound corresponding to at least 1% by weight of the solids.

### CROSS-REFERENCE TO RELATED APPLICATION

This application claims the benefit of U.S. Provisional Application No. 61/603,865 filed on Feb. 27, 2012, the disclosure of which is incorporated herein by reference in its entirety.

### FIELD OF THE INVENTION

The invention generally relates to ceramics and, more particularly, to chemically bonded ceramics based on boron and lead.

### BACKGROUND

Public acceptance is an important factor in the construction of new nuclear power plants, and addressing potential scenarios for the safe storage and transportation of spent fuel is important to maintain the public's trust. As such, there has been an ongoing debate on the suitability of the current cask designs used for transporting spent nuclear fuel—a type of high level waste—across the U.S. due to the potential for accidents. An issue that arises with the current designs of nuclear cask is that, while the designs can withstand high temperatures for short periods of time, there have been examples of traffic accidents that have resulted in temperatures and time periods exceeding current safety design parameters. If current designs of nuclear casks had been involved in those accidents, neutron shielding may have been lost, and, depending on the particular design, gamma shielding may have been partially or substantially fully lost as well.

It is against this background that a need arose to develop the chemically bonded ceramics and manufacturing processes described herein.

### SUMMARY

One aspect of this disclosure relates to a manufacturing process of a chemically bonded ceramic. In one embodiment, the manufacturing process includes: (1) combining an acidic liquid and solids to form a mixture; and (2) curing the mixture to form the chemically bonded ceramic. The solids include a boron compound corresponding to at least 1% by weight of the solids.

In another embodiment, the manufacturing process includes: (1) forming an aqueous mixture including (i) an acid and water in a combined amount corresponding to 33% to 67% by weight of the aqueous mixture, and (ii) a lead compound in an amount corresponding to at least 1% of a remaining weight of the aqueous mixture; and (2) reacting the acid and the lead compound in the aqueous mixture to form the chemically bonded ceramic.

Another aspect of this disclosure relates to a chemically bonded ceramic. In one embodiment, the chemically bonded ceramic includes: (1) a binding phase including at least one of boron phosphate and lead phosphate; and (2) particles dispersed in the binding phase and including at least one of boron oxide particles and lead oxide particles. The chemically bonded ceramic has a compressive strength of at least 5 MPa.

In another embodiment, the chemically bonded ceramic is formed by: (1) combining an acidic liquid and solids to form a mixture; and (2) curing the mixture to form the chemically bonded ceramic. The solids include a boron compound corresponding to at least 1% by weight of the solids.

In a further embodiment, the chemically bonded ceramic is formed by: (1) forming an aqueous mixture including (i) an acid and water in a combined amount corresponding to 33% to 67% by weight of the aqueous mixture, and (ii) a lead compound in an amount corresponding to at least 1% of a remaining weight of the aqueous mixture; and (2) reacting the acid and the lead compound in the aqueous mixture to form the chemically bonded ceramic.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: Cask designs for storage and transportation of spent nuclear fuel.

FIG. 2: Typical irradiation (disks) and compression (cylinders) samples.

FIG. 3: Europium spectrum used for irradiation tests.

FIG. 4: Irradiation setup for gamma rays: (a) representation of setup and (b) detail of a sample holder.

FIG. 5: Powders used in a chemically bonded phosphate ceramic: (a) Wollastonite and (b) lead oxide.

FIG. 6: Scanning Electron Microscope cross-section images for Wollastonite-based chemically bonded phosphate ceramics: (a) without lead oxide, (b) with about 10 weight % of lead oxide (based on total weight of solids), and (c) with about 50 weight % of lead oxide (based on total weight of solids).

FIG. 7: Topographical image for a Wollastonite-based chemically bonded phosphate ceramic with lead oxide, with different phases labeled by numbers.

FIG. 8: Compressive strength for chemically bonded phosphate ceramics with and without lead oxide: (a) error bars and (b) typical stress-strain curves.

FIG. 9: X-ray diffraction patterns for Wollastonite-based chemically bonded phosphate ceramics with lead oxide.

FIG. 10: Attenuation tests with Europium source and chemically bonded phosphate ceramics with different lead oxide contents. (a) and (b) show test results for lead oxide content of about 0 weight % and about 50 weight % (based on total weight of solids), respectively.

FIG. 11: (a) Linear attenuation coefficient and (b) mass attenuation coefficient.

FIG. 12: Neutron attenuation setup.

FIG. 13: Scanning Electron Microscope images of starting powders used to fabricate a chemically bonded phosphate ceramic: a) boron oxide; and b) Wollastonite.

FIG. 14: Scanning Electron Microscope images for boron-based chemically bonded phosphate ceramics.

FIG. 15: X-ray diffraction patterns for starting powders and chemically bonded phosphate ceramics.

FIG. 16: Compressive strengths for boron-based chemically bonded phosphate ceramics.

### DETAILED DESCRIPTION

### Definitions

The following definitions apply to some of the aspects described with respect to some embodiments of this disclosure. These definitions may likewise be expanded upon herein.

As used herein, the singular terms “a,” “an,” and “the” include plural referents unless the context clearly dictates otherwise. Thus, for example, reference to an object can include multiple objects unless the context clearly dictates otherwise.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable characteristics that are substantially the same as those of the non-spherical object. Thus, for example, a size of a non-spherical object can refer to a diameter of a corresponding spherical object that exhibits light scattering characteristics that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

### Chemically Bonded Ceramics

Manufacturing of sintered ceramics typically involves high temperatures during at least part of a manufacturing process, which is undesirable because of increased cost and negative environmental impact. An alternative to sintering is chemical bonding as in hydraulic cements, which allows these materials to be inexpensively manufactured in high volume production. Although sintered ceramics typically are expensive compared to hydraulic cements, sintered ceramics in general can have higher mechanical strength, corrosion resistance, and temperature stability. It is desirable to develop materials that have properties in between sintered cements and hydraulic ceramics to fill the gap between these materials.

Embodiments of this disclosure relate to chemically bonded ceramics (CBCs), which can combine thermomechanical properties of sintered ceramics with the ease of manufacturing of hydraulic cements. CBCs are desirable for a number of applications, such as shielding, encapsulation, neutralization, and immobilization of hazardous and radioactive waste, as well as structural materials for construction of nuclear plants.

CBCs correspond to a class of ceramics that are formed through acid-base and hydration reactions. CBCs typically reach their resulting mechanical properties by chemical reactions at low temperatures, rather than sintering at elevated temperatures as in conventional ceramics. CBCs can bridge the gap between properties of sintered ceramics and hydraulic cements. Advantageously, CBCs can have mechanical properties that are comparable to sintered ceramics along with high stability in acidic and high temperature environments. Specifically, CBCs can outperform hydraulic cements during prolonged contact with fire, and can withstand much higher temperatures before failing. In addition, manufacturing of CBCs can be inexpensive, castable, and environmentally friendly. Furthermore, through the incorporation of either, or both, boron and lead, CBCs are afforded with radiation shielding properties in combination with their desirable thermomechanical and manufacturing properties.

Chemically bonded phosphate ceramics (CBPCs) belong to the broader class of CBCs. CBPCs typically form by acid-base reactions between an acid, such as a phosphate-based acid (e.g., phosphoric acid), and a ceramic source, such as one including a metal oxide or a metal silicate. In the case of CBPCs, when an acidic liquid, such as an aqueous phosphoric acid solution, and a metal oxide are mixed, the oxide dissolves, and an acid-base reaction is initiated. The result is a mixture in the form of a slurry that hardens into a ceramic product. Bonding in CBPCs can include a mixture of ionic, covalent, and van der Waals bonding, with the ionic and covalent bonding dominating in some embodiments. In contrast for the case of conventional cement hydration products, van der Waals and hydrogen bonding typically dominate.

A CBPC of some embodiments of this disclosure is formed by incorporating either, or both, a boron compound (i.e., a boron-containing compound) and a lead compound (i.e., a lead-containing compound). A boron compound serves as a source of boron, and examples of suitable boron compounds include boron oxides, such as boron trioxide (B₂O₃), boron monoxide (B₂O), and boron suboxide (B₆O). A lead compound serves as a source of lead, and examples of suitable lead compounds include lead oxides, such as lead(II) oxide (PbO), lead(II,IV) oxide (Pb₃O₄ or 2PbO.PbO₂), lead dioxide (or lead(IV) oxide, PbO₂), lead sesquioxide (Pb₂O₃), and Pb₁₂O₁₉. Either, or both, a boron compound and a lead compound can serve as a source of a resulting ceramic, along with a suitable reinforcement material that can serve as an additional source of the ceramic. By incorporating a boron compound, CBPCs based on boron are afforded with neutron shielding properties, as evidence by, for example, increased linear attenuation coefficients for thermal neutrons. By incorporating a lead compound, CBPCs based on lead are afforded with gamma shielding properties, as evidence by, for example, increased linear attenuation coefficients for gamma radiation. And, by incorporating both a boron compound and a lead compound, CBPCs based on boron and lead correspond to hybrid materials that function as a combined neutron and gamma shield. In conjunction, CBPCs based on either, or both, boron and lead can exhibit excellent mechanical properties, including compression strengths superior to those of a conventional cement, which allows the CBPCs to be used as a substitute for cementitious materials. Additionally, a density of these CBPCs can be lower than a conventional cement, thereby opening up a number of applications where a combination of radiation shielding, high strength, and low weight is desirable, such as those related to structural applications in nuclear power plants. Other suitable radiation shielding materials can be incorporated in place of, or in combination with, boron and lead.

According to some embodiments of a boron-based CBPC, manufacturing of the CBPC is carried out by forming an aqueous mixture including an acid, water, and a boron compound. In some embodiments, the acid and water are introduced in a combined amount corresponding to about 10% to about 80% by weight of the aqueous mixture, such as from about 33% to about 67%, from about 40% to about 64%, from about 47% to about 60%, from about 50% to about 60%, or from about 52% to about 58% by weight of the aqueous mixture. In some embodiments, the boron compound is introduced in an amount corresponding to at least about 1% of a remaining weight of the aqueous mixture, such as at least about 2%, at least about 5%, at least about 10%, at least about 15%, at least about 20%, at least about 25%, at least about 30%, at least about 35%, at least about 40%, or at least about 45%, and up to about 50% (or more) of the remaining weight of the aqueous mixture. In some embodiments, calcium silicate, such as in the form of Wollastonite, also is introduced as an reinforcement material and as an additional ceramic source, and in an amount up to about 99% of the remaining weight of the aqueous mixture, such as up to about 98%, up to about 95%, up to about 90%, up to about 85%, up to about 80%, up to about 75%, up to about 70%, up to about 65%, up to about 60%, or up to about 55%, and down to about 50% (or less) of the remaining weight of the aqueous mixture. Maintaining the amount of the boron compound up to about 50% of the remaining weight of the aqueous mixture can be desirable for some embodiments to promote consolidation of a slurry into a solid, although consolidation can be achieved with higher amounts of the boron compound through drying and heating operations, such as using a furnace.

According to some embodiments of a lead-based CBPC, manufacturing of the CBPC is carried out by forming an aqueous mixture including an acid, water, and a lead compound. In some embodiments, the acid and water are introduced in a combined amount corresponding to about 10% to about 80% by weight of the aqueous mixture, such as from about 33% to about 67%, from about 40% to about 64%, from about 47% to about 60%, from about 50% to about 60%, or from about 52% to about 58% by weight of the aqueous mixture. In some embodiments, the lead compound is introduced in an amount corresponding to at least about 1% of a remaining weight of the aqueous mixture, such as at least about 2%, at least about 5%, at least about 10%, at least about 15%, at least about 20%, at least about 25%, at least about 30%, at least about 35%, at least about 40%, or at least about 45%, and up to about 50% (or more) of the remaining weight of the aqueous mixture. In some embodiments, calcium silicate, such as in the form of Wollastonite, also is introduced as an reinforcement material and as an additional ceramic source, and in an amount up to about 99% of the remaining weight of the aqueous mixture, such as up to about 98%, up to about 95%, up to about 90%, up to about 85%, up to about 80%, up to about 75%, up to about 70%, up to about 65%, up to about 60%, or up to about 55%, and down to about 50% (or less) of the remaining weight of the aqueous mixture. Maintaining the amount of the lead compound up to about 50% of the remaining weight of the aqueous mixture can be desirable for some embodiments to promote consolidation of a slurry into a solid, although consolidation can be achieved with higher amounts of the lead compound through drying and heating operations, such as using a furnace.

According to some embodiments of a CBPC incorporating both boron and lead, manufacturing of the CBPC is carried out by forming an aqueous mixture including an acid, water, a boron compound, and a lead compound. In some embodiments, the acid and water are introduced in a combined amount corresponding to about 10% to about 80% by weight of the aqueous mixture, such as from about 33% to about 67%, from about 40% to about 64%, from about 47% to about 60%, from about 50% to about 60%, or from about 52% to about 58% by weight of the aqueous mixture. In some embodiments, the boron compound and the lead compound are introduced in a combined amount corresponding to at least about 2% of a remaining weight of the aqueous mixture, such as at least about 5%, at least about 10%, at least about 15%, at least about 20%, at least about 25%, at least about 30%, at least about 35%, at least about 40%, or at least about 45%, and up to about 50% (or more) of the remaining weight of the aqueous mixture. In some embodiments, calcium silicate, such as in the form of Wollastonite, also is introduced as an reinforcement material and as an additional ceramic source, and in an amount up to about 98% of the remaining weight of the aqueous mixture, such as up to about 95%, up to about 90%, up to about 85%, up to about 80%, up to about 75%, up to about 70%, up to about 65%, up to about 60%, or up to about 55%, and down to about 50% (or less) of the remaining weight of the aqueous mixture. Maintaining a combined amount of the boron compound and the lead compound up to about 50% of the remaining weight of the aqueous mixture can be desirable for some embodiments to promote consolidation of a slurry into a solid, although consolidation can be achieved with higher amounts of the boron compound and the lead compound through drying and heating operations, such as using a furnace. Depending upon the particular application and a desired balance for shielding and thermomechanical properties, the boron compound can be introduced in a higher amount relative to the lead compound, the lead compound can be introduced in a higher amount relative to the boron compound, or the boron compound and the lead compound can be introduced in substantially equal amounts.

As part of forming the aqueous mixture, the acid can be introduced in a liquid form, such as an acidic liquid. Specifically, an aqueous solution of the acid is provided, and the aqueous solution of the acid is combined with solids to form the aqueous mixture, where the solids include calcium silicate (or another reinforcement material as a powder) and either, or both, a boron compound (as a powder) and a lead compound (as a powder). Combining the aqueous solution of the acid with different types of solids can be carried out sequentially or substantially simultaneously. In some embodiments, the aqueous solution of the acid is initially combined with calcium silicate to form an intermediate mixture, and this intermediate mixture is then combined with remaining solids (including either, or both, the boron compound and the lead compound) to form the resulting aqueous mixture. Such sequential incorporation of solids in some embodiments can extend a pot life and decrease the variability of resulting mechanical properties. Examples of suitable acids include phosphate-based acids, such as phosphoric acid (H₃PO₄). In the case of an aqueous phosphoric acid solution, a concentration of phosphoric acid can be in a range of about 0.1% to about 50% by weight of the aqueous phosphoric acid solution, such as from about 0.1% to about 10%, from about 10% to about 20%, from about 20% to about 30%, from about 30% to about 40%, or from about 40% to about 50% by weight of the aqueous phosphoric acid solution. Other acidic liquids also are contemplated.

In some embodiments, the aqueous solution of the acid and the solids are combined in a weight ratio in a range of about 0.1:1 to about 4:1, such as from about 0.5:1 to about 2:1, from about 0.7:1 to about 1.8:1, from about 0.9:1 to about 1.5:1, from about 1:1 to about 1.5:1, or from about 1.1:1 to about 1.4:1. Maintaining the weight ratio of liquid to solids within such specified ranges can be desirable for some embodiments to promote sufficient reaction and consolidation of a slurry into a solid.

According to some embodiments of a boron-based CBPC, the boron compound corresponds to at least about 1% by weight of all solids combined with the aqueous solution of the acid to form the aqueous mixture, such as at least about 2%, at least about 5%, at least about 10%, at least about 15%, at least about 20%, at least about 25%, at least about 30%, at least about 35%, at least about 40%, or at least about 45%, and up to about 50% (or more) by weight of all solids combined with the aqueous solution.

According to some embodiments of a lead-based CBPC, the lead compound corresponds to at least about 1% by weight of all solids combined with the aqueous solution of the acid to form the aqueous mixture, such as at least about 2%, at least about 5%, at least about 10%, at least about 15%, at least about 20%, at least about 25%, at least about 30%, at least about 35%, at least about 40%, or at least about 45%, and up to about 50% (or more) by weight of all solids combined with the aqueous solution.

According to some embodiments of a CBPC incorporating both boron and lead, the boron compound and the lead compound, as combined, correspond to at least about 2% by weight of all solids combined with the aqueous solution of the acid to form the aqueous mixture, such as at least about 5%, at least about 10%, at least about 15%, at least about 20%, at least about 25%, at least about 30%, at least about 35%, at least about 40%, or at least about 45%, and up to about 50% (or more) by weight of all solids combined with the aqueous solution.

In other embodiments of forming the aqueous mixture, the acid can be introduced in a solid form, such as a powder. Specifically, water, the acid in a powdered form, and remaining solids are combined in any suitable order to form the aqueous mixture. Examples of suitable acids in a powdered form include phosphate-based salts, such as phosphoric acid, alkali metal phosphates, and aluminum dihydrogen phosphate.

Additional components can be introduced in the aqueous mixture. For example, additives such as periclase, borax (Na₂B₄O₇.10H₂O), boric acid (H₃BO₃), Fly ash, and others can be introduced to modify resulting properties and to control setting time. One or more of these additives can be introduced in a combined amount up to about 2% or up to about 1% by weight of the aqueous mixture.

As part of forming the aqueous mixture, the various components are combined using any suitable mixing or agitation mechanism. In some embodiments, a suitable mixing time varies according to an amount of a boron compound (or a lead compound) introduced in the aqueous mixture, with a lower amount of the boron compound (or the lead compound) translating into a shorter mixing time, and a larger amount of the boron compound (or the lead compound) translating into a longer mixing time. For example, the mixing time can vary in a range of about 10 sec to about 20 min or longer, with a lower portion of this range for the case when the aqueous mixture includes a lower amount of the boron compound (or the lead compound), and with an upper portion of this range for the case when the aqueous mixture includes a larger amount of the boron compound (or the lead compound).

Once formed, the aqueous mixture is cured to form a resulting CBPC product. Curing can be carried out at moderate temperatures that are significantly lower than sintering processes used for conventional ceramics. In some embodiments, curing is carried out at a temperature up to about 150° C., such as up to about 120° C., up to about 110° C., up to about 100° C., up to about 90° C., up to about 80° C., up to about 70° C., up to about 60° C., or up to about 50° C., and down to about room temperature or somewhat below room temperature. In some embodiments, a suitable curing or setting time varies according to an amount of a boron compound (or a lead compound) introduced in the aqueous mixture, with a lower amount of the boron compound (or the lead compound) translating into a shorter setting time, and a larger amount of the boron compound (or the lead compound) translating into a longer setting time. For example, the setting time can vary in a range of a few seconds to a day or more, such as from about 20 min to about 1 hr or longer, with a lower portion of this range for the case when the aqueous mixture includes a lower amount of the boron compound (or the lead compound), and with an upper portion of this range for the case when the aqueous mixture includes a larger amount of the boron compound (or the lead compound).

As part of curing, the acid reacts with the solids in the aqueous mixture to form the CBPC product, where the solids include calcium silicate (or another reinforcement material) and either, or both, a boron compound and a lead compound. The resulting CBPC product includes a binding phase, which can be amorphous, crystalline, or both, and particles bonded and dispersed in the binding phase. The binding phase serves as a ceramic matrix, and is formed as a result of acid-base reactions between phosphoric acid and chemical components present in the solids. The particles correspond to residual particles remaining from the acid-base reactions, such as one or more of residual Wollastonite particles, residual boron oxide particles, and residual lead oxide particles. Either, or both, the boron oxide particles and the lead oxide particles can have sizes in a range of about 0.5 μm to about 300 μm.

In some embodiments, the binding phase of the CBPC product includes one or more phosphate phases. The amount and types of phases formed and their interrelation in properties of the CBPC product can be controlled, and the CBPC product can be used for different applications involving specific chemistry, pH, and different properties.

An example of a phosphate phase is brushite (CaHPO₄.2H₂O), which can be formed based on the following reaction between calcium silicate and phosphoric acid:

CaSiO₃+H₃PO₄+2H₂O→SiO₂.H₂O+CaHPO₄.2H₂O

Under time and temperature, brushite sometimes can lose bonded water molecules and can transform into a more stable phase, monetite (CaHPO₄).

Another example of a phosphate phase is boron phosphate (BPO₄), which can be formed as boron oxide dissolves to form boric acid, and the boric acid reacts with phosphoric acid based on the following reaction:

H₃PO₄+H₃BO₃→BPO₄+3H₂O

Further examples of phosphate phases include one or more lead phosphates, which can be formed based on the following reactions between lead oxide (or dissolved lead or lead ions) and phosphoric acid:

PbO+H₃PO₄→PbHPO₄+H₂O

Pb²⁺+HPO₄²⁻→PbHPO₄

3Pb+2H₃PO₄→3H₂+Pb₃(PO₄)₂

In some embodiments, the CBPC product is a low density material, with a density (e.g., bulk density) up to about 2.2 g/cm³, such as up to about 2.1 g/cm³, up to about 2 g/cm³, up to about 1.9 g/cm³, up to about 1.8 g/cm³, up to about 1.7 g/cm³, or up to about 1.6 g/cm³, and down to about 1.5 g/cm³, down to about 1.4 g/cm³, down to about 1.3 g/cm³, or less. In some embodiments, a porosity of the CBPC product can be in a range of about 5% to about 40%, such as from about 10% to about 35%, from about 10% to about 30%, from about 15% to about 25%, from about 15% to about 23%, from about 15% to about 20%, or from about 18% to about 20%.

In some embodiments, the CBPC product is a high strength material, with a compressive strength of at least about 5 MPa, such as at least about 10 MPa, at least about 15 MPa, at least about 20 MPa, at least about 25 MPa, at least about 30 MPa, at least about 40 MPa, at least about 50 MPa, at least about 60 MPa, or at least about 70 MPa, and up to about 80 MPa, up to about 90 MPa, up to about 100 MPa, or more. In some embodiments, a resulting compressive strength varies according to an amount of the boron compound (or the lead compound) introduced in the aqueous mixture during manufacturing, with a higher amount of the boron compound (or the lead compound) translating into a smaller compressive strength, and a smaller amount of the boron compound (or the lead compound) translating into a higher compressive strength.

In some embodiments, the CBPC product is afforded with neutron shielding properties, with a linear attenuation coefficient for thermal neutrons (e.g., at about 0.025 eV) of at least about 0.061 cm⁻¹, such as at least about 0.065 cm⁻¹, at least about 0.07 cm⁻¹, at least about 0.075 cm⁻¹, at least about 0.08 cm⁻¹, or at least about 0.085 cm⁻¹, and up to about 0.09 cm⁻¹, up to about 0.095 cm⁻¹, up to about 0.1 cm⁻¹, or more. Alternatively, or in combination with such neutron shielding properties, the CBPC product is afforded with gamma shielding properties, with a linear attenuation coefficient for gamma radiation (e.g., at about 1 MeV) of at least about 0.05 cm⁻¹, such as at least about 0.055 cm⁻¹, at least about 0.06 cm⁻¹, at least about 0.065 cm⁻¹, at least about 0.07 cm⁻¹, at least about 0.075 cm⁻¹, or at least about 0.08 cm⁻¹, and up to about 0.095 cm⁻¹, up to about 0.1 cm⁻¹, up to about 0.12 cm⁻¹, or more.

### Applications of Chemically Bonded Ceramics

The CBCs described herein are desirable for a number of applications in nuclear engineering, such as materials for shielding, encapsulation, neutralization, and immobilization of hazardous and radioactive wastes, as well as structural materials for construction of nuclear plants. Because the setting time of the CBCs can be controlled from a few seconds to days, the CBCs can be used in emergencies that involve water or other leaks in nuclear plants. Depending on the nature and pH of a radioactive waste, a composition of a CBC can be tuned to allow consolidation into a ceramic that is stable over time and is substantially insoluble in water.

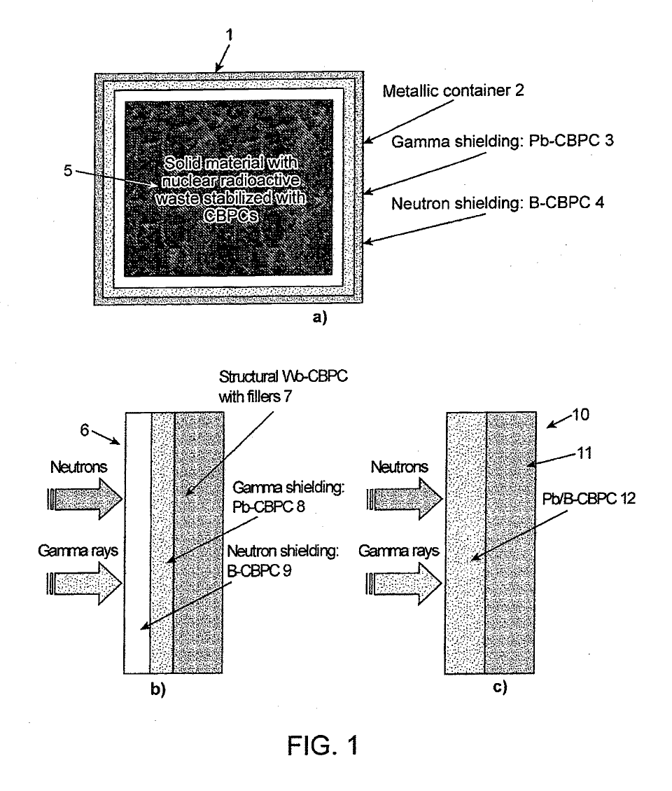

FIG. 1a), b), and c) show examples of cask designs that incorporate the CBCs described herein and can be used for storage and transportation of spent nuclear fuel.

FIG. 1a) shows a cross-section view of a cask 1 that includes a metallic container 2 forming an exterior of the cask 1, along with a gamma shielding layer 3 and a neutron shielding layer 4 adjacent to the metallic container 2 and facing an interior of the cask 1. The gamma shielding layer 3 is formed from a lead-based CBPC described herein, and the neutron shielding layer 4 is formed from a boron-based CBPC described herein. Disposed within the interior of the cask 1 is a radioactive waste 5, which is mixed with and stabilized by one or more CBPCs, such as one incorporating either, or both, boron and lead. The order of the metallic container 2, the gamma shielding layer 3, and the neutron shielding layer 4 can be varied from that shown in FIG. 1a).

FIG. 1b) shows a cross-section view of a portion of a cask 6 that includes a container 7 forming an exterior of the cask 6, along with a gamma shielding layer 8 and a neutron shielding layer 9 adjacent to the container 7 and facing an interior of the cask 6. In place of a metallic container, the container 7 shown in FIG. 1b) is formed from a Wollastonite-based CBPC, with the substantial absence of boron and lead contents. Other aspects of the cask 6 can be similarly implemented as described for the cask 1 of FIG. 1a).

FIG. 1c) shows a cross-section view of a portion of a cask 10 that includes a container 11 forming an exterior of the cask 10, along with a combined neutron and gamma shielding layer 12 adjacent to the container 11 and facing an interior of the cask 10. The combined neutron and gamma shielding layer 12 is formed from a CBPC incorporating both boron and lead as described herein, and the container 11 is formed from a metal, a metal alloy, a Wollastonite-based CBPC, or another structural material. Other aspects of the cask 10 can be similarly implemented as described for the casks 1 and 6 of FIGS. 1a) and b).

### EXAMPLES

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

### Lead-Based CBPCs

In this example, the shielding properties to gamma rays as well as the effect of lead concentration incorporated into CBPCs are presented. The Wollastonite-based CBPC was fabricated by mixing an aqueous phosphoric acid solution (H₃PO₄) with Wollastonite powder (CaSiO₃). The Wollastonite-based CBPC is a composite material with several crystalline and amorphous phases. Irradiation experiments were conducted on different Wollastonite-based CBPCs incorporating lead oxide (PbO). Radiation shielding potential, attenuation coefficients in a broad range of energies pertinent to engineering applications, and density experiments showing the effect of the lead oxide additions (to improve gamma shielding capabilities) are also presented. Microstructure was identified by using a Scanning Electron Microscope (SEM) and X-ray diffraction (XRD).

Wollastonite powder and PbO powder mixed with a phosphoric acid solution in a weight ratio of about 100/120 powders to acid react into a CBPC. In CBPCs, when the aqueous phosphoric acid solution and the Wollastonite powder mixture are stirred, oxides dissolve, and an acid-base reaction is initiated, resulting in a slurry that hardens into a ceramic product. PbO powder was added to the mixture while keeping substantially constant the total amount of solids (Wollastonite and PbO). The PbO was used to determine its effect on the attenuation coefficient of the CBPC.

The mixing of Wollastonite with phosphoric acid produced a composite material with brushite (CaHPO₄.2H₂O) and Wollastonite as crystalline phases, and silica and amorphous calcium phosphates as amorphous phases. It is expected that PbO introduced to the mixture appears as a crystalline phase, and some as dispersed Pb in the amorphous phosphate matrix.

The sections below present the compression strength, curing properties, density, gamma attenuation results, and XRD and SEM characterization for Wollastonite-based CBPCs with PbO contents.

Experimental:

Samples Manufacturing

CBPC samples were fabricated by mixing an aqueous phosphoric acid solution and natural Wollastonite powder (M200 from Minera Nyco; see Table 1) in a 1.2 weight ratio liquid to powder. Also, lead (II) oxide (from Alfa Aesar; see Table 2) was added to the mixture. For all samples, the 1.2 ratio of liquid (phosphoric acid solution) to powders (Wollastonite and PbO) was maintained substantially constant (see Table 3).

The mixing process of the starting components was conducted in a Planetary Centrifugal Mixer (Thinky Mixer® AR-250, TM). It is observed that, when a temperature of the components is reduced, the pot life of the resulting product is increased, and the viscosity is decreased, which affects the quality of the product. Thus, for compression and irradiation samples, the starting components were first stored in a refrigerator for about one hour at about 3° C. in independent and closed containers.

For curing test samples, starting components were maintained at about room temperature in order to determine the effect of PbO on the pot life. It is also contemplated that the pot life can be extended by various ways, such as by thermal processing, aging the starting components, or incorporating additives in the starting components.

TABLE 1
Chemical composition of Wollastonite powder (weight %)

| | Composition | | | | | | | |
|---|---|---|---|---|---|---|---|---|
| | CaO | SiO₂ | Fe₂O₃ | Al₂O₃ | MnO | MgO | TiO₂ | K₂O |
| Percentage | 46.25 | 52.00 | 0.25 | 0.40 | 0.025 | 0.50 | 0.025 | 0.15 |

TABLE 2
Chemical composition of PbO powder (weight %)

| Composition | PbO | Pb | Fe₂O₃ |
|---|---|---|---|
| Percentage | 99.97 | 0.03 | 0.0002 |

TABLE 3
Starting component amounts in CBPC samples fabricated

| | Wollastonite | | Total | Phosphoric acid |
|---|---|---|---|---|
| CBPC-2PbO | (g) | PbO (g) | powders (g) | formulation (g) |
| CBPC | 100 | 0 | 100 | 120 |
| CBPC-2PbO | 98 | 2 | 100 | 120 |
| CBPC-10PbO | 90 | 10 | 100 | 120 |
| CBPC-50PbO | 50 | 50 | 100 | 120 |

Irradiation Tests

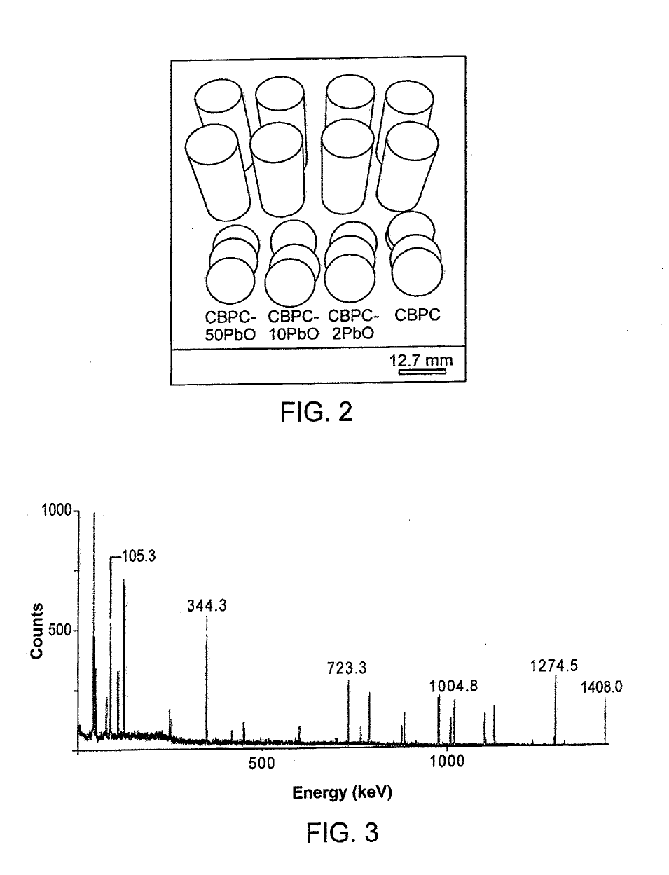

Irradiation samples were fabricated using glass molds of about 12.7 mm in diameter and about 100 mm in length. Then, a diamond saw was used to cut sample discs of about 0.1 mm thick. Samples were then ground using silicon carbide papers of grit ANSI 400. Finally, samples were dried in a furnace at about 100° C. for about 24 hr in order to stabilize the water content. FIG. 2 shows the irradiation disks and the compression samples.

PbO was incorporated in the samples to evaluate the effect of Pb in attenuating gamma and X-rays and for shielding applications. In general, high Z nuclei and high density materials can be more effective at shielding gamma radiation. Pb is a stable high Z material, with high density, and relatively low cost.

The samples were tested to determine the linear attenuation coefficients at various energies using a calibrated Europium source with isotopes of Europium-152, Europium-154, and Europium-155. This source presents 14 different peaks, yielding a wide range of gamma energies to evaluate attenuation. Six energies were evaluated. An example of the spectrum is shown in FIG. 3.

The linear attenuation coefficient is calculated using I=Iₒe^{-μx}, where I₀ is the intensity of an uncollided beam, I is the intensity of the beam after it has passed through the sample, x is the thickness of the sample in cm, and μ is the linear attenuation coefficient measured in cm⁻¹.

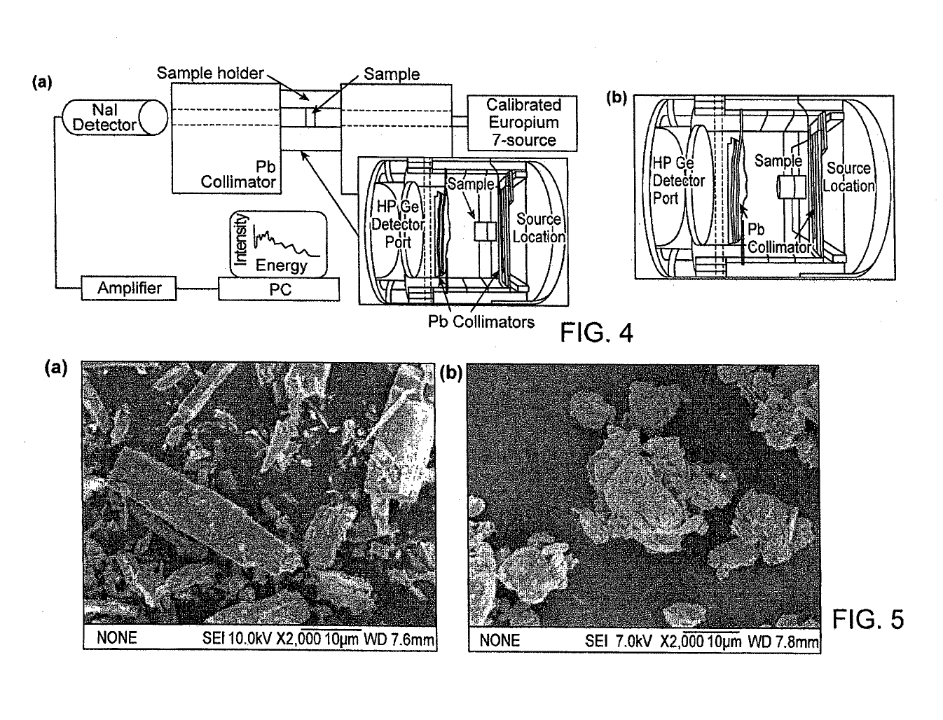

The setup for irradiation with gamma rays with the Europium gamma source is shown in FIG. 4a. An image of the sample holder is also shown in FIG. 4b. A high purity Germanium detector was used to obtain peaks for the Europium source. A first lead collimator is used to form a beam of gamma particles that will strike the sample, and the uncollided particles pass through and are detected by the Germanium detector. The particles that are scattered by the sample are absorbed in a second collimator if the particles are scattered at an angle. Some slowing of the particles does occur, and these particles are removed from the analysis by subtracting baselines of the γ-peaks. Measurements are performed inside a heavily shielded facility to reduce a background signal.

Compression Tests

For samples without PbO, the starting components were mixed for about 2 min. For samples with PbO, first Wollastonite and the acidic solution were mixed for about 1 min, and, when PbO was added, the components were mixed for about 1 more min. Samples were fabricated using glass molds of about 12.7 mm in diameter and about 100 mm in length. Then, a diamond saw was used to cut cylinders of about 28 mm in length. Samples were ground (with silicon carbide papers of grit ANSI 400) using a metallic mold until flat, parallel, and smooth surfaces were obtained. The final length was about 25.4 mm. Samples were dried in a furnace at about 100° C. for about 24 hr in order to stabilize the water content. Compression tests were conducted in an Instron® machine 3382. A set of 5 samples were tested for each composition of Table 3. The crosshead speed was about 1 mm/min.

Other Characterization

To evaluate the microstructure, sample sections were initially ground using silicon carbide papers grit ANSI 240, 400, and 1200 progressively, and then the samples were polished with alumina powders of about 1, about 0.3, and about 0.05 μm grain size progressively. After polishing, samples were dried in a furnace at about 100° C. for about 24 hr and observed in an optical microscope. For SEM examination, samples were mounted on an aluminum stub and sputtered in a Hummer 6.2 system (about 15 mA AC for about 30 s), yielding an about 1 nm thick film of Au. The SEM used was a JEOL JSM 6700R in high vacuum mode. Elemental distribution X-ray maps were collected on the SEM with an energy-dispersive X-ray spectroscopy analyzer (SEM-EDS). Images were collected on the polished and gold-coated samples, with a counting time of about 51.2 ms/pixel.

XRD experiments were conducted using an X'Pert PRO (Cu Kα radiation, λ=1.5406 Å) at about 45 KV and scanning between about 10° and about 80°. M200, M400 and M1250 Wollastonite samples (before and after the drying process) were ground in an alumina mortar, and XRD tests were carried out at about room temperature.

For density tests, samples were tested after the drying process set forth above in a Metter Toledo™ balance, by way of the buoyancy method. The Dry Weight (Wd), Submerged Weight (Ws), and Saturated Weight (Wss) were measured. The following parameters were calculated: Bulk volume: Vb=Wss−Ws; Apparent volume: Vapp=Wd−Ws; Open-pore volume: Vop=Wss−Wd; % porosity=(Vop/Vb)×100%; Bulk Density: Db=Wd/(Wss−Ws); and Apparent Density: Da=Wd/(Wd−Ws). In these calculations, the density of water was taken to be 1.0 g/cm^{3.}

Analysis and Results:

FIG. 5a and b show Wollastonite and PbO powders respectively. Wollastonite grains are needle-like shaped, while PbO grains do not have a specific shape.

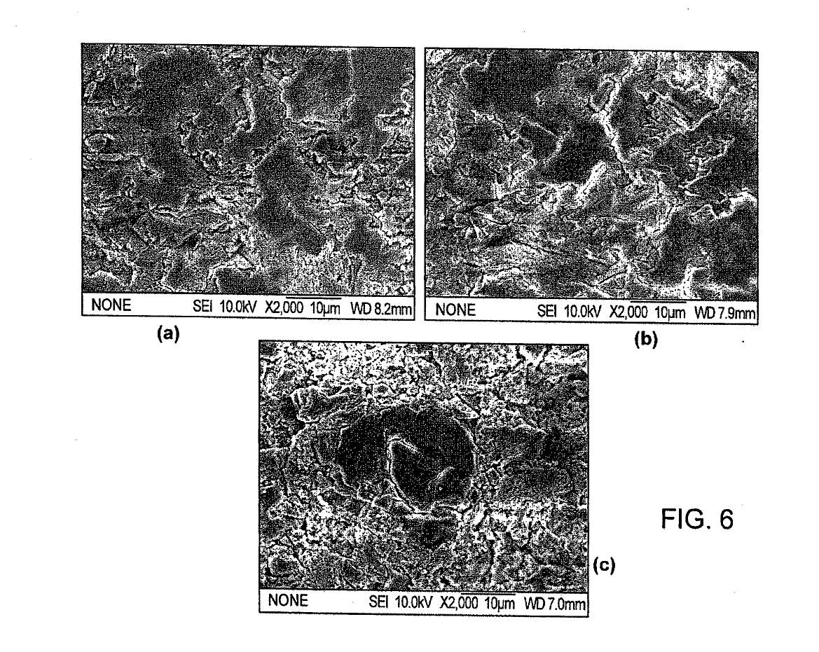

FIG. 6 shows SEM cross-section images for Wollastonite-based CBPCs taken at the same magnification. FIG. 6a, b, and c show Wollastonite-based CBPCs with 0, about 10, and about 50 weight % of PbO respectively (based on total weight of solids). The grains correspond to remaining Wollastonite, silica, and remaining PbO.

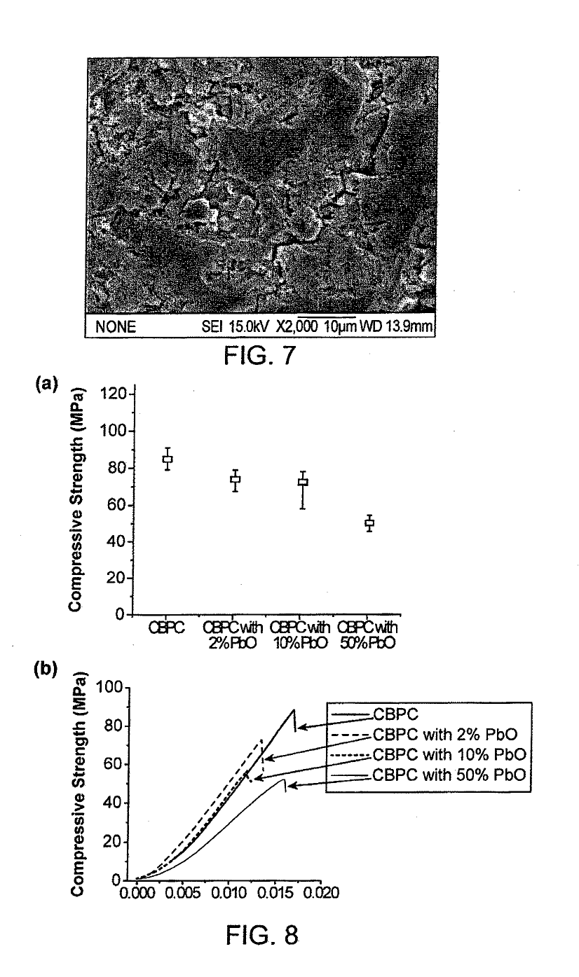

FIG. 7 shows a topographical image for a Wollastonite-based CBPC with PbO, with different phases labeled by numbers. The numbers 1, 2, 3, and 4 correspond to (1) Wollastonite; (2) silica; (3) amorphous calcium phosphate; and (4) lead phosphates and lead oxide, respectively. Some remaining particles of PbO are present as well as Pb in a phosphate matrix, which may indicate that new amorphous phases are formed by the dissolution of Pb in the phosphoric acid solution.

FIG. 8a shows the compressive strength for the CBPCs with PbO contents. The standard deviation was larger for the sample with 10 weight % of PbO. When either the concentration of Wollastonite or PbO was large, the error bars were low. Also, in all cases, the compressive strength for the CBPCs was superior to values for a Portland cement concrete (about 30 MPa). FIG. 8b shows typical compression curves for the CBPCs with PbO contents.

FIG. 9 shows XRD patterns for the fabricated CBPC samples with PbO contents. The Wollastonite-based CBPC is a composite material with several crystalline (Wollastonite and brushite) and amorphous phases (silica and amorphous calcium phosphates). By adding PbO, remaining PbO appears in the XRD patterns. The intensity of PbO peaks increases at higher concentrations of PbO in the composite.

Density results (which are the mean of six measurements) presented in Table 4 show that, when PbO concentration was increased, the bulk density was increased, and the percentage of porosity was decreased.

TABLE 4
Density tests for Wollastonite-based CBPCs with PbO

| Sample | | Wd (g) | Ws (g) | Wss (g) | Vb (cm³) | Vapp (cm³) | Vop (cm³) | Db (g/cm³) | Da (g/cm³) | % Per |
|---|---|---|---|---|---|---|---|---|---|---|
| CBPC | Mean | 0.340 | 0.179 | 0.385 | 0.206 | 0.161 | 0.045 | 1.652 | 2.112 | 21.758 |
| | SD | 0.031 | 0.020 | 0.035 | 0.017 | 0.011 | 0.006 | 0.024 | 0.050 | 1.068 |
| CBPC with 2% PbO | Mean | 0.284 | 0.139 | 0.320 | 0.180 | 0.145 | 0.036 | 1.576 | 1.564 | 19.786 |
| | SD | 0.013 | 0.0130 | 0.011 | 0.003 | 0.002 | 0.003 | 0.094 | 0.090 | 1.227 |
| CBPC with 10% PbO | Mean | 0.323 | 0.165 | 0.361 | 0.197 | 0.158 | 0.038 | 1.644 | 2.040 | 19.417 |
| | SD | 0.010 | 0.006 | 0.012 | 0.005 | 0.004 | 0.002 | 0.021 | 0.043 | 0.792 |
| CBPC with 50% PbO | Mean | 0.370 | 0.231 | 0.401 | 0.170 | 0.139 | 0.031 | 2.177 | 2.657 | 15.373 |
| | SD | 0.004 | 0.0041 | 0.004 | 0.002 | 0.002 | 0.001 | 0.026 | 0.040 | 0.577 |

FIG. 10 shows the gamma attenuation tests with Europium source and the CBPCs with different PbO contents. It is observed that the Europium is substantially fully attenuated at low energies and that high energy gamma particles are less attenuated in each case. The energy peaks were evaluated by integrating the area underneath the peaks (number of counts) for each energy. For the low energy peaks, attenuation was substantially complete, and so the peaks were removed from the analysis. This should not pose an issue since a shield designed for high energy attenuation is expected to also attenuate lower energies. For the 50 weight % PbO composition, the attenuation reduced all peaks below about 123.1 keV to background, indicating sufficiently high attenuation coefficients for energies below about 344.3 keV. At higher energies, there is a decrease in the attenuation coefficients since the gamma particles travel through the samples with greater ease (as expected).

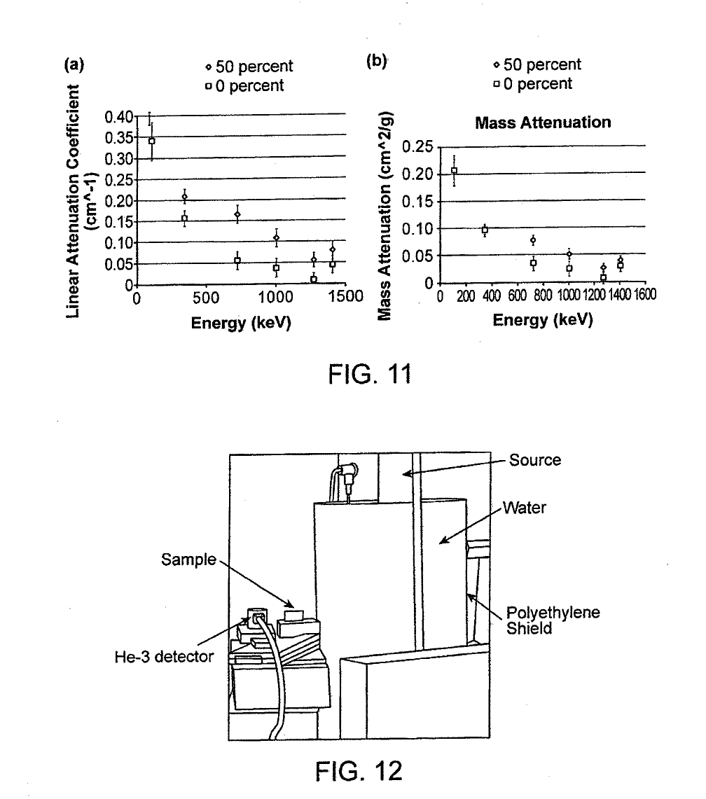

FIG. 11a shows the change in linear attenuation coefficients for the CBPC sample with 50 weight % of PbO. There is a substantial increase in the attenuation of gamma rays (more than about 100%), yielding values desirable for practical applications.

The manufacturing of Wollastonite-based CBPCs with PbO contents is demonstrated in this example. The mixing order of the starting components can have an effect on the final properties. It has been observed that mixing first the components of the Wollastonite-based CBPCs and then incorporating the PbO contents extend the pot life and decrease the variability of the compressive strength, as compared with samples where all starting components were mixed at the same time. Also, the SEM results show that Pb was dissolved into the amorphous phosphate matrix, potentially producing amorphous lead phosphates mixed with amorphous calcium phosphates and silica. Other materials that appear in the CBPCs are crystalline: Wollastonite and likely brushite. These characteristics allow the CBPCs to encapsulate different nuclear wastes, since the composition of a ceramic matrix can be tailored by introducing new species. Also, the amount and distribution of phases can be tuned to optimize other properties like mechanical properties for structural applications. Since the CBPCs start from a liquid mixture, a variety of reinforcement materials can be introduced, which would allow the use of these ceramics with wastes (introduced in the microstructure) for specific infrastructure developments.

For the compression tests, it was observed that variability was low in general for CBPC samples with PbO when compared to other ceramics and cements. Also, the compressive strength for the CBPC samples was superior to those for a Portland cement concrete. These results demonstrate the desirability of this class of materials as a superior radiation shielding solution as well as playing a role in the infrastructure of nuclear plants.

With respect to shielding capabilities, the incorporation of Pb in the samples increased the linear attenuation coefficient substantially. At about 1 MeV, the value almost triples (from about 0.039 to about 0.109 cm⁻¹). The linear attenuation coefficient of an 1 at. % Pb-doped CBPC reached about 14% of the value for lead (about 0.109 versus about 0.77 cm⁻¹ for lead) and up from about 5% for a ceramic without doping. Without wishing to be bound by a particular theory, it is expected that part of this increase is due to intrinsic increase of the mass attenuation coefficient from using a higher Z material (Pb) and another part is due to the increase in apparent density (Da increased from about 2.1 to about 2.7 g/cm³). Also, due to the weight of Pb, the 1 at. % Pb-doped sample corresponds to about 11.4 weight % of Pb. The net improvement of attenuation coefficient for 1 MeV gamma radiation was about 180.9% (the improvement at different energies above about 300 keV was about 32.4%, about 193.8%, about 180.9%, about 44.9%, and about 78%).

With the addition of PbO, mass attenuation coefficients of a CBPC compares favorably to other gamma shields as shown in Table 5. At about 1 MeV, the mass attenuation coefficient of the CBPC is better than concrete. At higher energies, the coefficient compares favorably with iron and concrete.

TABLE 5
Mass attenuation coefficients for gamma shields

| | | | | | |
|---|---|---|---|---|---|
| Energy (MeV) | CPBC | CPBC (50% PbO) | Concrete | Iron | Lead |

Mass attenuation coefficient (cm²/g)

| | | | | | |
|---|---|---|---|---|---|
| 0.1 | 0.161 | | 0.167 | 0.334 | 5.337 |
| 0.3 | 0.096 | 0.096 | 0.107 | 0.105 | 0.373 |
| 0.8 | 0.034 | 0.076 | 0.071 | 0.066 | 0.084 |
| 1 | 0.024 | 0.050 | 0.064 | 0.060 | 0.068 |
| 1.5 | 0.027 | 0.037 | 0.052 | 0.049 | 0.051 |

The improvement of linear attenuation coefficients implies that the about 11.43 cm (about 4.5 in.) to about 14.61 cm (about 5.75 in.) gamma shield formed of lead in nuclear casks can be replaced with a ceramic shield of about 84 cm (about 33.1 in.) to about 107 cm (about 42.1 in.) in thickness. This can be desirable for transportation applications, as well as for above ground storage.

### Example 2

### Boron-Based CBPCs

This example demonstrates fast setting ceramics fabricated from boron oxide and Wollastonite powders, which are desirable for nuclear waste transport, disposal, stabilization, and radiation shielding applications. The boron oxide is mixed with calcium silicate and phosphoric acid to consolidate into a ceramic by an acid-base reaction. The resulting materials have high compression strength when compared with cements and with other materials for the treatment of nuclear wastes, and are suitable as fire resistant shielding materials. Nuclear attenuation, compressive strength, XRD, and SEM experiments were used to characterize these materials.

Experimental:

Samples Manufacturing

CBPC samples were fabricated by mixing an aqueous phosphoric acid solution and natural Wollastonite powder (CaSiO₃; M200 from Minera Nyco; see Table 1). Also, boron oxide powder (B₂O₃; from Alfa Aesar; see Table 6) was added to the mixture. For all samples, the 1.2 weight ratio of liquid (phosphoric acid solution) to powders (Wollastonite and B₂O₃) was maintained substantially constant (see Table 7). The mixing process of the components was conducted in a Planetary Centrifugal Mixer (Thinky Mixer® AR-250, TM). First, Wollastonite was mixed with the acidic liquid for about 1 min, and then boron oxide was added and mixed for about 1 min. All samples were dried for about 2 days at about 100° C. in order to stabilize the weight.

TABLE 6
Chemical composition of B₂O₃ powder (weight %)

| Composition | B₂O₃ | SO₄ | Al₂O₃ | Cl | H₂O (insoluble) |
|---|---|---|---|---|---|
| Percentage | 95.00 | 0.7 | 0.1 | 0.2 | 0.02 |

TABLE 7
Starting component amounts in CBPC samples fabricated

| | | | Total | Phosphoric |
|---|---|---|---|---|
| Sample | Wollastonite | | powders | acid |
| composition | (CaSiO₃) (g) | B₂O₃ (g) | (g) | formulation (g) |
| CBPC | 100 | 0 | 100 | 120 |
| CBPC-2 B₂O₃ | 98 | 2 | 100 | 120 |
| CBPC-10 B₂O₃ | 90 | 10 | 100 | 120 |
| CBPC-15 B₂O₃ | 85 | 15 | 100 | 120 |
| CBPC-20 B₂O₃ | 80 | 20 | 100 | 120 |

Characterization

For compression tests, samples were fabricated using glass molds of about 12.7 mm in diameter and about 100 mm in length. A diamond saw was used to cut cylinders of about 28 mm in length. Samples were ground (with silicon carbide papers of grit ANSI 400) using a metallic mold until flat, parallel, and smooth surfaces were obtained. The final length was about 25.4 mm. Compression tests were conducted in an Instron® machine 3382. A set of 5 samples was tested for each composition of Table 7. The crosshead speed was about 1 mm/min. For SEM examination (sample sections were ground using silicon carbide papers grit ANSI 240, 400 and 1200 progressively), samples were mounted on an aluminum stub and sputtered in a Hummer 6.2 system (about 15 mA AC for about 30 sec), yielding an about 1 nm thick film of Au. The SEM used was a JEOL JSM 6700R in high vacuum mode. XRD experiments were conducted using an X'Pert PRO (Cu Kα radiation, λ=1.5406 Å) at about 45 KV and scanning between about 10° and about 80°. M200, M400, and M1250 Wollastonite samples (before and after the drying process) were ground in an alumina mortar, and XRD tests were carried out at about room temperature. The above characterization was conducted for the compositions summarized in Table 7. A similar set of experiments for PbO additions (instead of B₂O₃) is presented in Example 1.

To determine the shielding effect of CBPCs, a method for measuring the attenuation of neutrons was implemented. In order to allow for quick measuring of the attenuation coefficients, a He-3 neutron detector was used. The He-3 detector provides a count of thermal neutrons over a set time period. This detector was connected to a lower level discriminator to reduce noise and a scaler to obtain counts. A PuBe neutron source was used. The production of neutrons from the PuBe source occurs when an alpha particle released from plutonium reacts with beryllium in the source according to the reaction:

⁴₂He+⁹₄Be→¹²₆C+¹₀n

This reaction produces neutrons with a wide energy range.

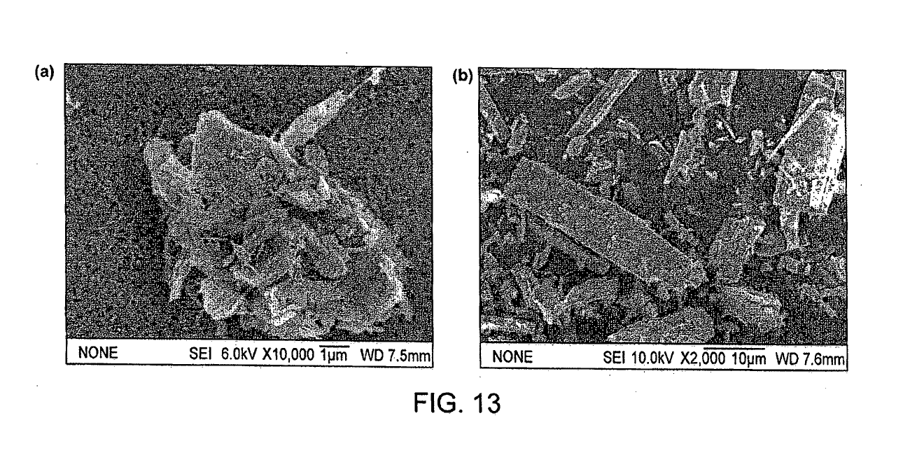

Since the spectrum of the PuBe source includes more fast neutrons than thermal neutrons, a method for thermalizing the neutrons was used. The average distance for thermalizing a fast neutron in water is about 12.7 cm (estimated from the neutron age for fast neutrons of about 27 cm²). The source was suspended in water in a container of low density polyethylene with a distance to a wall of about 9 cm. The samples were placed on a platform with the edge of the sample about 1 cm to about 2 cm away from the polyethylene wall. The samples were then counted using a He-3 detector with about 10 minute count rates, with and without an overlying cadmium shield (about 0.6 mm). When present, the cadmium shield absorbs substantially all the thermalized neutrons travelling through the samples, and the difference measured with and without the cadmium shield yields the neutron difference to calculate the attenuation for the samples. An image of the setup is shown in FIG. 12.

Results and Analysis:

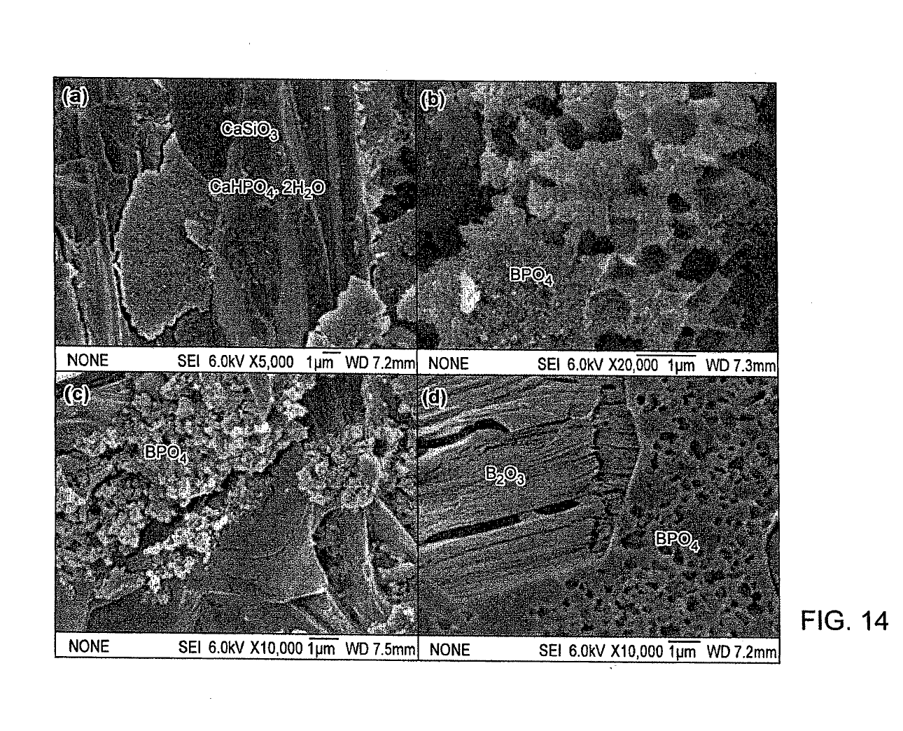

FIG. 13 shows boron oxide and Wollastonite powders respectively. Wollastonite grains are needle-like shaped, while B₂O₃ grains do not have a specific shape.

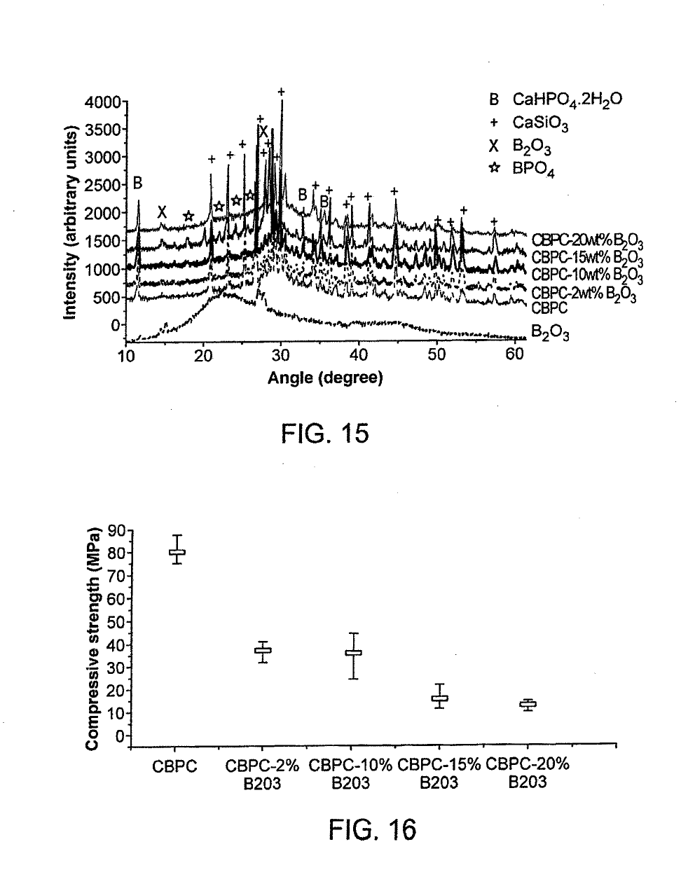

FIG. 14 shows SEM images for the CBPCs fabricated. CaSiO₃, CaHPO₄.2H₂O, BPO₄, and B₂O₃ phases have been identified in the images. These results were confirmed by XRD data as shown in FIG. 15. FIG. 15 shows XRD patterns for the starting components (starting powders) and CBPCs fabricated using the starting components. CaSiO₃, CaHPO₄.2H₂O, BPO₄, and B₂O₃ phases are shown. B₂O₃ is mostly amorphous. Brushite (CaHPO₄.2H₂O) is expected to result from a reaction between CaSiO₃ and H₃PO₄. Brushite and boron phosphate are binding phases.

FIG. 16 shows the compressive strength for the CBPCs with B₂O₃ contents. The standard deviation was larger for the sample with 10 weight % of B₂O₃. As the B₂O₃ content increases, the compressive strength was observed to decrease.

Results for the neutron attenuation experiments for several different CBPCs are summarized in Table 8. From the results, the incorporation of boron improved the attenuation of the CBPCs by about 48% for thermal neutrons, while the incorporation of PbO yielded a decrease in attenuation by about 25%. For applications as a shielding material, a balance between boron oxide and lead oxide can yield a suitable hybrid material with desirable mechanical properties that can attenuate both gammas and neutrons. The CBPC with boron oxide content also compared favorably with boron oxide during the testing, showing an improvement in thermal neutron attenuation.

TABLE 8
Thermal neutron attenuation values for CBPCs

| | Thickness (cm) | Linear Attenuation (cm⁻¹) | Error |
|---|---|---|---|
| 20% Boron | 2.774 | 0.089 | 0.017 |
| 0% | 1.664 | 0.060 | 0.018 |
| 50% PbO | 1.284 | 0.045 | 0.023 |
| Boron oxide | 1.308 | 0.068 | — |

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A manufacturing process of a chemically bonded ceramic, comprising:
combining an acidic liquid and solids to form a mixture, wherein the solids include a boron compound corresponding to at least 1% by weight of the solids; and
curing the mixture to form the chemically bonded ceramic.

2. The manufacturing process of claim 1, wherein the boron compound corresponds to boron oxide.

3. The manufacturing process of claim 1, wherein the boron compound corresponds to at least 2% and up to 50% by weight of the solids.

4. The manufacturing process of claim 1, wherein combining the acidic liquid and the solids includes:
combining the acidic liquid and calcium silicate to form an intermediate mixture; and
combining the intermediate mixture and the boron compound.

5. The manufacturing process of claim 1, wherein the acidic liquid and the solids are combined in a weight ratio in a range of 0.5:1 to 2:1.

6. The manufacturing process of claim 1, wherein the solids include a lead compound corresponding to at least 1% by weight of the solids.

7. The manufacturing process of claim 6, wherein a combined amount of the boron compound and the lead compound is at least 2% and up to 50% by weight of the solids.

8. The manufacturing process of claim 1, wherein the acidic liquid corresponds to an aqueous phosphoric acid solution.

9. The chemically bonded ceramic formed by the manufacturing process of claim 1.

10. A manufacturing process of a chemically bonded ceramic, comprising:
forming an aqueous mixture including
an acid and water in a combined amount corresponding to 33% to 67% by weight of the aqueous mixture, and
a lead compound in an amount corresponding to at least 1% of a remaining weight of the aqueous mixture; and
reacting the acid and the lead compound in the aqueous mixture to form the chemically bonded ceramic.

11. The manufacturing process of claim 10, wherein the acid corresponds to phosphoric acid, and the lead compound corresponds to lead oxide.

12. The manufacturing process of claim 10, wherein the lead compound corresponds to at least 2% and up to 50% of the remaining weight of the aqueous mixture.

13. The manufacturing process of claim 10, wherein the aqueous mixture further includes calcium silicate in an amount up to 98% of the remaining weight of the aqueous mixture.

14. The manufacturing process of claim 13, wherein forming the aqueous mixture includes:
combining an aqueous solution of the acid and the calcium silicate to form an intermediate mixture; and
combining the intermediate mixture and the lead compound to form the aqueous mixture.

15. The manufacturing process of claim 10, wherein the aqueous mixture further includes a boron compound in an amount corresponding to at least 1% of the remaining weight of the aqueous mixture.

16. The chemically bonded ceramic formed by the manufacturing process of claim 10.

17. A chemically bonded ceramic, comprising:
a binding phase including at least one of boron phosphate and lead phosphate; and
particles dispersed in the binding phase and including at least one of boron oxide particles and lead oxide particles,
wherein the chemically bonded ceramic has a compressive strength of at least 5 MPa.

18. The chemically bonded ceramic of claim 17, wherein the chemically bonded ceramic has a linear attenuation coefficient for thermal neutrons of at least 0.065 cm⁻¹.

19. The chemically bonded ceramic of claim 17, wherein the chemically bonded ceramic has a linear attenuation coefficient for gamma radiation at 1 MeV of at least 0.06 cm⁻¹.

20. The chemically bonded ceramic of claim 17, wherein the compressive strength of the chemically bonded ceramic is at least 10 MPa.
